(19) United States
(12) Patent Application Publication
(10) Pub. No.: US 2009/0241347 A1
(43) Pub. Date: Oct. 1, 2009

(54) Combined spoon and chop sticks eating utensil

(76) Inventor: Michael Weaver, La Crescenta, CA (US)

Correspondence Address: Roy L. Anderson, Esq.;WAGNER, ANDERSON & BRIGHT, LLP., 3541 Ocean View Boulevard, Glendale, CA, 91208, US

(21) Appl. No.: 12/079,570

(22) Filed: Mar. 27, 2008

(51) Int. Cl. A47J 43/28

(52) U.S. Cl. 30/142

(57) ABSTRACT

An eating utensil with a spoon portion connected to two sticks by a connection constructed so that the utensil can be used as a spoon for eating or the two sticks can be used to pick up food in the manner of use of a pair of chop sticks. The connection between the spoon portion (which can have a spoon undercut proximate the connection for retaining a liquid in a shallow bowl relative to the connection) and the two sticks can be formed integrally while the two sticks can be curved so the two sticks and connection have a shape approximating a wishbone. A pair of indents proximate the connection is formed in an inner surface of each of the two sticks (and possibly in the under surface as well) to make it easier for an inner surface of each of the two sticks to be moved toward each other by a person applying pressure on the outer surface of each of the two sticks so as to force the two inner surfaces toward one another.

### CROSS REFERENCE TO RELATED APPLICATIONS

This application is related to U.S. Design Pat. D539,615 to the same inventor.

### FIELD OF THE INVENTION

The present invention is in the field of eating utensils.

### BACKGROUND OF THE INVENTION

Spoons have been known and used as eating utensils for a long time. They work especially well for liquids, such as soups.

Chop sticks have been known and used as eating utensils for a long time as well. They have been especially popular in Asia for centuries. However, one cannot eat soup with chop sticks, so soup in such situations is either eaten by raising the bowl to one's mouth or by use of a spoon designed for soup.

In the United States there are many people who know how to use chop sticks, but there are also a great many people, including children, who have not begun using chop sticks at a very early age and who, thus, need to learn how to use chop sticks. Thus, for restaurants serving Chinese or Asian food where chop sticks are expected, such restaurants must also have forks, and possible also knives, available for patrons who are uncomfortable with the use of chop sticks. Plus, there is still a need for spoons for soups and the like.

Despite the millions of people who have eaten at such restaurants for quite some time, and the expense associated with having multiple eating utensils available for patrons, nobody has come up with a solution to this duality and limited functionality of traditional chop sticks. It is to this situation that the present invention is directed.

### SUMMARY OF INVENTION

The present invention is generally directed to an eating utensil with a spoon portion connected to two sticks by a connection constructed so that the utensil can be used as a spoon for eating or the two sticks can be used to pick up food in the manner of use of a pair of chop sticks.

In a first separate group of aspects of the present invention, the connection between the spoon portion (which can have a spoon undercut proximate the connection for retaining a liquid in a shallow bowl relative to the connection) and the two sticks is formed integrally with the spoon portion and two sticks while the two sticks are curved so the two sticks and connection have a shape approximating a wishbone.

In a second separate group of aspects of the present invention, a pair of indents proximate the connection is formed in an inner surface of each of the two sticks (and possibly in the under surface as well) to make it easier for an inner surface of each of the two sticks to be moved toward each other by a person applying pressure on the outer surface of each of the two sticks so as to force the two inner surfaces toward one another.

Accordingly, it is a primary object of the present invention to provide an improved eating utensil with a spoon portion and a portion that can be used in the manner of chop sticks.

This and further objects and advantages will be apparent to those skilled in the art in connection with the drawings and the detailed description of the invention set forth below.

### BRIEF DESCRIPTION OF THE DRAWINGS

FIG. 1 is a top view of an eating utensil in accordance with the present invention.

FIG. 2 is a side view of the utensil shown in FIG. 1.

FIG. 3 illustrates use of the spoon portion of the utensil shown in FIG. 1.

FIG. 4 illustrates use of the sticks portion of the utensil shown in FIG. 1.

### DETAILED DESCRIPTION OF THE DRAWINGS

The present invention provides an eating utensil that combines the advantages and functionality of a spoon with a pair of chopsticks.

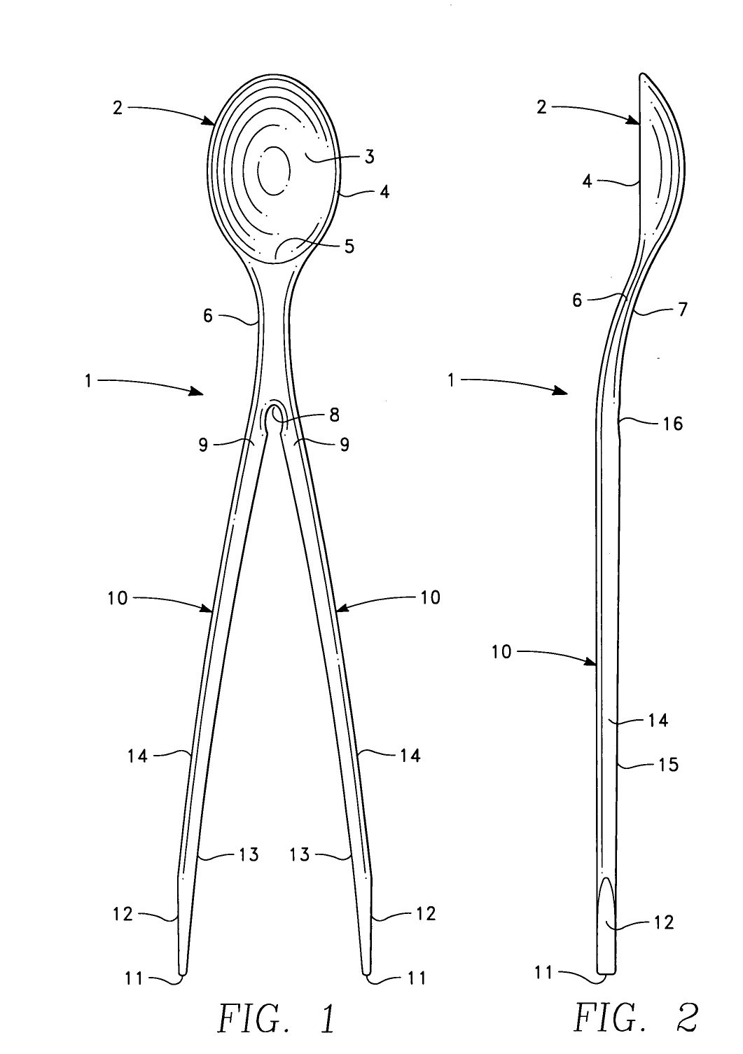

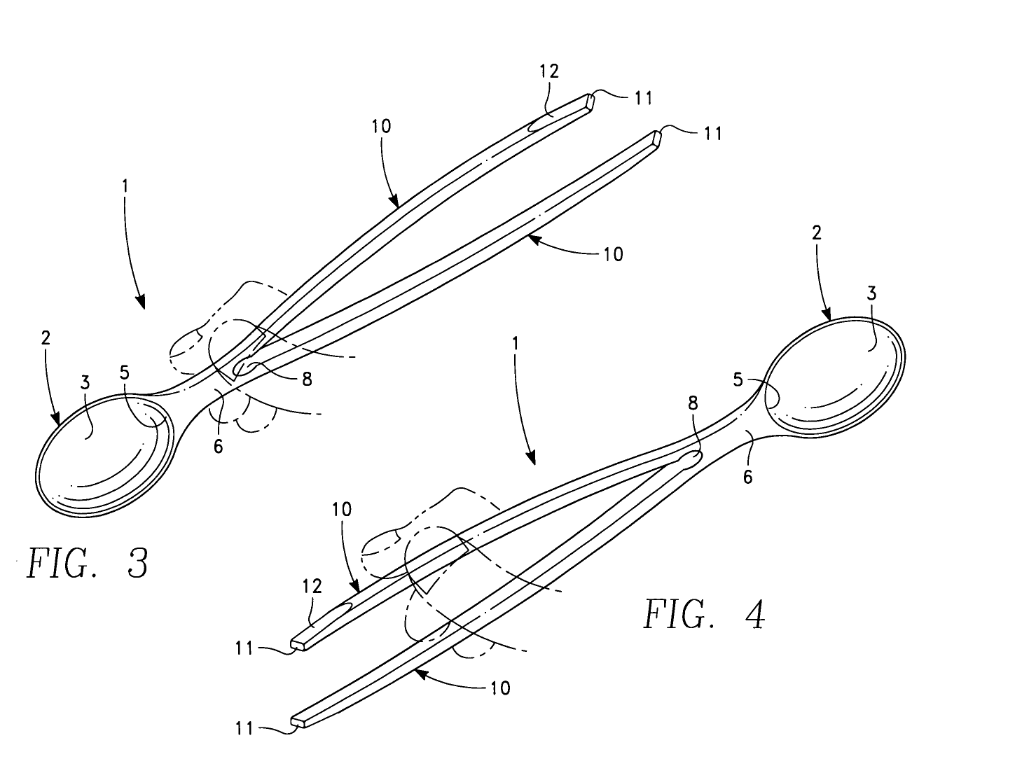

The present invention will now be discussed in connection with preferred embodiments illustrated in FIGS. 1-4.

In the Figures and the following more detailed description, numerals indicate various features of the invention, with like numerals referring to like features throughout both the drawings and the description. Although the Figures are described in greater detail below, the following is a glossary of the elements identified in the Figures.
1 Spatchi™ eating utensil
2 spoon portion
3 spoon bowl
4 spoon rim
5 spoon undercut
6 connection between spoon and stick portions
7 curve
8 indent
9 transition between indent 8 and inner surface 13 of stick 10
10 stick
11 end of stick 10
12 angled portion of stick 10
13 inner surface of stick 10
14 outer surface of stick 10 opposite surface 13
15 bottom surface of stick 10
16 bottom indent

A Spatchi™ eating utensil according to the present invention, generally designated as 1, has a spoon portion 2 that has a bowl 3 and a rim 4. A pair of sticks 10 is joined to spoon portion 2 by connection 6. There is a spoon undercut 5 proximate the connection 6 for retaining a drop or two of liquid in bowl 3 relative to the connection 6 when sticks 10 of utensil 1 are being used after spoon portion 2 has been dipped into a liquid. The amount of liquid retained in undercut 5 is small, but the function of undercut 5 is to prevent a small amount of liquid that might be retained in bowl 3 after use from dribbling down onto connection 6, and then possibly down onto sticks 10.

Each of sticks 10 has an end 11, an inner surface 13, an outer surface 14 opposite inner curved surface 13 and a bottom surface 15. It has been determined that it is especially preferred for inner surfaces 13 of the two sticks 10 to be curved, as shown in the figures, so the two inner surfaces joined to connection 6 have a shape approximating a wishbone. This shape makes it easier to use the sticks 10 as chopsticks, especially when such curved inner surfaces 13 are combined with indents 8.

Sticks 10 are joined to connection 6 and have an indent 8 proximate connection 6 in the inner surface 13 of each of the two sticks 10 so that a transition 9 is formed between indent 8 and inner surface 13 of each stick 10. The indents 8 function to make it easier for inner surfaces 13 of sticks 10 to be moved toward each other by a person using the Spatchi™ eating utensil 1 and applying pressure on outer surfaces 14 of sticks 10 so as to force the two inner surfaces 13 toward one another. It has been found that it may also be especially preferred in some circumstances, depending upon the dimensions of utensil 1, for indents 8 to also be partially cut from bottom surface 15 of each of the two sticks, to thus form bottom indents 16, where they are joined to connection 6. Again, the function of indents 8, as well as having inner surfaces 13 curve inwardly, is to facilitate ease of use of utensil 1 and make it easier for a person using utensil 1 to apply pressure on outer surfaces 14 so as to use sticks 10 in a manner similar to use of chop sticks.

A Spatchi™ eating utensil according to the present invention can be formed from an injection molding in which connection 6 is formed integrally with spoon portion 2 and sticks 10 in a single mold as shown in the figures, and is especially preferred it have a length of approximately 10 inches.

In conclusion, the present invention discloses a single eating utensil that can be used as both a spoon and a pair of chopsticks. Because sticks 10 are joined to connection 10, it is easier for a person unfamiliar with the use of chopsticks to learn how to use sticks 10 as chopsticks, and this may even help to familiarize such people in how to use detached chopsticks. However, for a restaurant or catering service, the present invention offers many advantages. No longer is it necessary to provide both chop sticks and a spoon, and no longer is it necessary to worry about whether a patron can use chop sticks, because utensil 1 is easier to use than chop sticks. However, even for one familiar with the use of chopsticks, the Spatchi™ eating utensil 1 is still a suitable utensil. Accordingly, it offers many advantages and, because it is a single utensil, cost savings as well.

Finally, anecdotal evidences suggests that the novelty of the Spatchi™ eating utensil 1 creates a certain amount of excitement, and not just with users, but also with people who have used chopsticks all of their lives. At first, a reaction might be that such a utensil is not appropriate—it is not traditional. But, after the initial exposure to this new utensil sinks it, it has been met with acclaim: Where can I get one? So, even though chop sticks have been used by hundreds of years by hundreds of millions of people, there is amazement at this new invention, especially once its functionality is recognized.

While the invention has been described herein with reference to certain preferred embodiments, those embodiments have been presented by way of example only, and not to limit the scope of the invention. Additional embodiments thereof will be obvious to those skilled in the art having the benefit of this detailed description. Further modifications are also possible in alternative embodiments without departing from the inventive concept.

Accordingly, it will be apparent to those skilled in the art that still further changes and modifications in the actual concepts described herein can readily be made without departing from the spirit and scope of the disclosed inventions as defined by the following claims.

What is claimed is:

1. An eating utensil, comprising:
a spoon portion;
two sticks; and
a connection between the spoon and the two sticks;
wherein the eating utensil can be used as a spoon for eating or the two sticks can be used to pick up food in the manner of use of a pair of chop sticks.

2. The eating utensil of claim 1, wherein the connection between the spoon portion and the two sticks is formed integrally with the spoon portion and two sticks.

3. The eating utensil of claim 1, Wherein the spoon portion has a spoon undercut proximate the connection for retaining a liquid in a shallow bowl relative to the connection.

4. The eating utensil of claim 1, further comprising: a pair of indents proximate the connection in an inner surface of each of the two sticks.

5. The eating utensil of claim 4, wherein the pair of indents function to make it easier for an inner surface of each of the two sticks to be moved toward each other by a person using the utensil and applying pressure on an outer surface of each of the two sticks so as to force the two inner surfaces toward one another.

6. The eating utensil of claim 5, wherein the pair of indents is cut from the inner surface of each of the two sticks where they are joined to the connection.

7. The eating utensil of claim 6, wherein the pair of indents is also partially cut from a bottom surface of each of the two sticks where they are joined to the connection.

8. The eating utensil of claim 6, wherein the inner surface of each of the two sticks is curved between the connection and an end of the two sticks.

9. The eating utensil of claim 8, wherein the two sticks and connection have a shape approximating a wishbone.

10. The eating utensil of claim 1, wherein the pair of indents makes it easier for the inner surface of each of the two sticks to be moved toward each other by a person using the utensil and applying pressure on an outer surface of each of the two sticks so as to force the two inner surfaces toward one another.

11. The eating utensil of claim 1, wherein the length of the utensil is approximately ten inches.

12. The eating utensil of claim 1, wherein the inner surface of each of the two sticks is curved between the connection and an end of the two sticks.

13. An eating utensil, comprising:
a spoon portion with a bowl;
two sticks;
a connection between the spoon and the two sticks; and
a pair of indents proximate the connection in an inner surface of each of the two sticks;
wherein the eating utensil can be used as a spoon for eating or the two sticks can be used to pick up food in the manner of use of a pair of chop sticks; and
wherein the pair of indents function to make it easier for the inner surface of each of the two sticks to be moved toward each other by a person using the utensil and applying pressure on an outer surface of each of the two sticks so as to force the two inner surfaces toward one another.

14. The eating utensil of claim 13, wherein the spoon portion has a spoon undercut proximate the connection for retaining a liquid in a shallow bowl relative to the connection.

15. The eating utensil of claim 13, wherein the inner surface of each of the two sticks is curved between the connection and an end of the two sticks so that the two sticks and connection have a shape approximating a wishbone.

16. The eating utensil of claim 15, wherein the pair of indents is cut from the inner surface of each of the two sticks where they are joined to the connection.

17. The eating utensil of claim 16, wherein the pair of indents is also partially cut from a bottom surface of each of the two sticks where they are joined to the connection.
